(19) United States
(12) Patent Application Publication
(10) Pub. No.: US 2016/0259895 A1
(43) Pub. Date: Sep. 8, 2016

(54) System and Method for Real Time Updates of Progress of Medical Procedures

(71) Applicants: Patrick Austermann, Princeton, NJ (US); Samuel Scott Becker, Princeton, NJ (US)

(72) Inventors: Patrick Austermann, Princeton, NJ (US); Samuel Scott Becker, Princeton, NJ (US)

(21) Appl. No.: 14/641,402

(22) Filed: Mar. 8, 2015

(51) Int. Cl. G06F 19/00; H04W 4/14; H04W 12/02; H04L 12/58

(52) U.S. Cl. CPC G06F 19/327; G06F 19/322; H04L 51/046; H04W 4/14; H04W 12/02

(57) ABSTRACT

System and Method for Real Time Updates of Progress of Medical Procedures. This invention enables several users of a provider such as doctors and nurses to send one-way real time messages about the progress of a procedure to multiple recipients. As sessions are identified by a random key, users are not required to divulge personal information or set up accounts to access the system. When new messages are posted to a session, users may optionally choose to be notified by text messages or emails. Messages are selected from templates that are specific to the provider. Messages may be sent from and received on multiple network connected computers, laptops, mobile ort medical devices at the same time.

### CROSS-REFERENCES TO RELATED APPLICATIONS

US 20140324497 TRACKING BUSINESS PROCESSES AND INSTANCES

US 20140067418 Method And System For Facilitating Communication Between A Patient And A Care Provider

US 20110059727 Simple Mobile Registration: A mechanism enabling people to use electronic mobile devices and their messaging capabilities-instead of the traditionally used personal computer-to sign-up or register in real time for access to services and applications delivered via mobile devices

US 20110071851 Method, Apparatus And Computer Program Product For Facilitating Patient Progression Toward Discharge

US 20110161110 System And Method For An Online Platform Distributing Condition Specific Programs Used For Monitoring The Health Of A Participant And For Offering Health Services To Participating Subscribers

US 20100017222 Systems and Methods For Scheduling Healthcare Visits

US 20080313005 System And Method For Real-time Scheduling Of Human And Non-human Resources

U.S. Pat. No. 8,010,717 Method And System For Communication And Collaboration Between A Patient And Healthcare Professional

U.S. Pat. No. 8,090,742 Patient Directed System And Method For Managing Medical Information

U.S. Pat. No. 8,271,596 Apparatus And Methods For Controlling The Transmission Of Messages

U.S. Pat. No. 8,894,577 System and method for medical information monitoring and processing

U.S. Pat. No. 8,880,462 Method, system and apparatus for providing information to client devices within a network

U.S. Pat. No. 8,688,466 Data synchronization for booking of healthcare appointments across practice groups

U.S. Pat. No. 8,700,424 Platform for connecting medical information to services for medical care

U.S. Pat. No. 8,370,186 System and method for providing web-based management solutions

U.S. Pat. No. 8,924,523 System and method for sharing updated information with known users

### BACKGROUND

During procedures such as medical and healthcare-related procedures, there are often several parties interested in receiving real-time updates of the progress of the procedure. This system and method pertains to a novel way for medical and health-care providers to transmit such updates in the form of textual messages in a timely manner while minimizing the burden on all parties and at the same time preserving the privacy of the patient and of the person(s) receiving the update.

### BRIEF SUMMARY OF THE INVENTION

Today, communication between a health-care provider and a patient's family members during a procedure is usually ad-hoc and in person, and consequently limited to individuals waiting at the medical facility. It is inconvenient for both the family members and the staff if the family members repeatedly inquire with the medical staff about the procedure's progress, and a burden on both. The proposed system and method enables privacy-preserving, one way and near real time communication between several parties while significantly alleviating this burden.

In one embodiment of this invention, one party may be comprised of a plurality of individuals (users) providing updates (the provider), while the other party (the consumer) may consist of a plurality of individuals (users) receiving updates. These updates are organized in sessions which are identified by secret, unique random keys, enabling the anonymous subscription to message updates by all individuals who are given access to this session key. A provider uses a set of templates from which to pick messages that are transmitted to all recipients that subscribe to the session. In one embodiment, sessions and their associated messages are stored persistently in a database or the file system. In another embodiment, sessions and their associated messages are only kept in the system's main memory and are not persisted.

### DESCRIPTION OF THE DRAWINGS

FIG. 1. FIG. 1 shows the welcome page one embodiment of the system as it is presented to any users visiting the system's portal. Users can always return to this page via link 101. The provider's users proceed to the provider view in FIG. 2. by selecting link 102. Consumers enter a session key into text entry field 103 and thus proceed to the consumer view (see FIG. 5.)

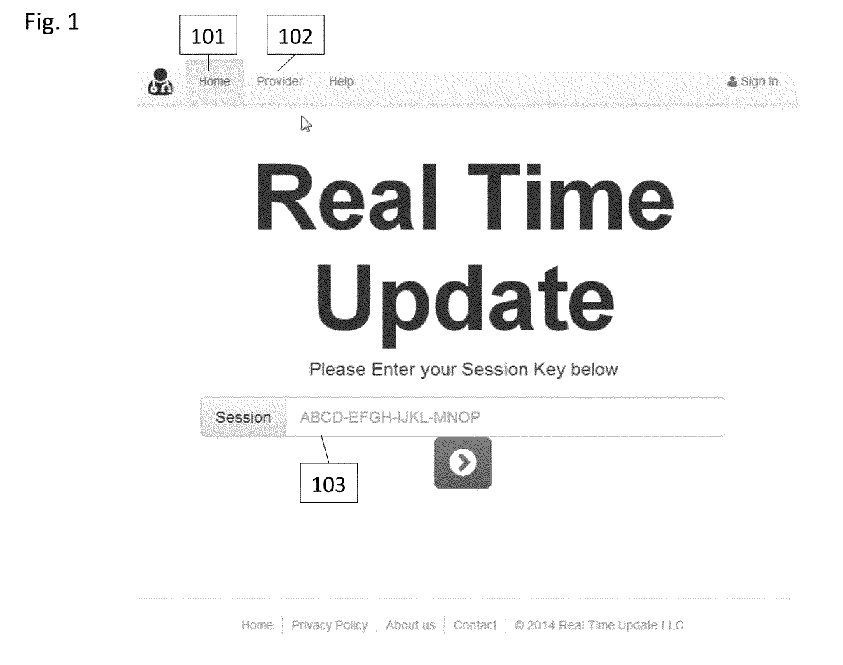

FIG. 2. FIG. 2 illustrates the provider's view. Here, active sessions can be selected 201 or new sessions can be created 202 (see also FIG. 3.). Active sessions can be temporarily hidden by selecting 203 or deleted by selecting 204. To change the active procedure (message template), the user selects 205 (see also FIG. 4). Selecting a message 206 from the active template will add it to the session and transmit it to all subscribed recipients, including users of the same provider and consumers with subscribed to this session. The most recent message of the active session can be deleted by selecting 207.

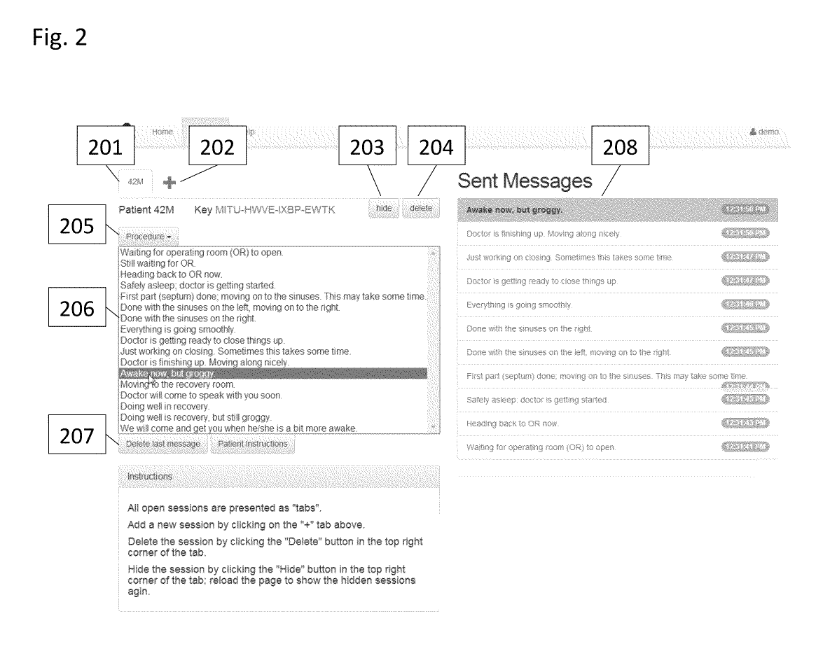

FIG. 3. FIG. 3 presents the creation of a new session by the provider, where after supplying information about the patient 301, shortened name 302, doctor in charge 303, the facility 304, the facility's contact information 305 and one or more cell phone numbers to which text messages are sent 306, the provider created the session by selecting button 307.

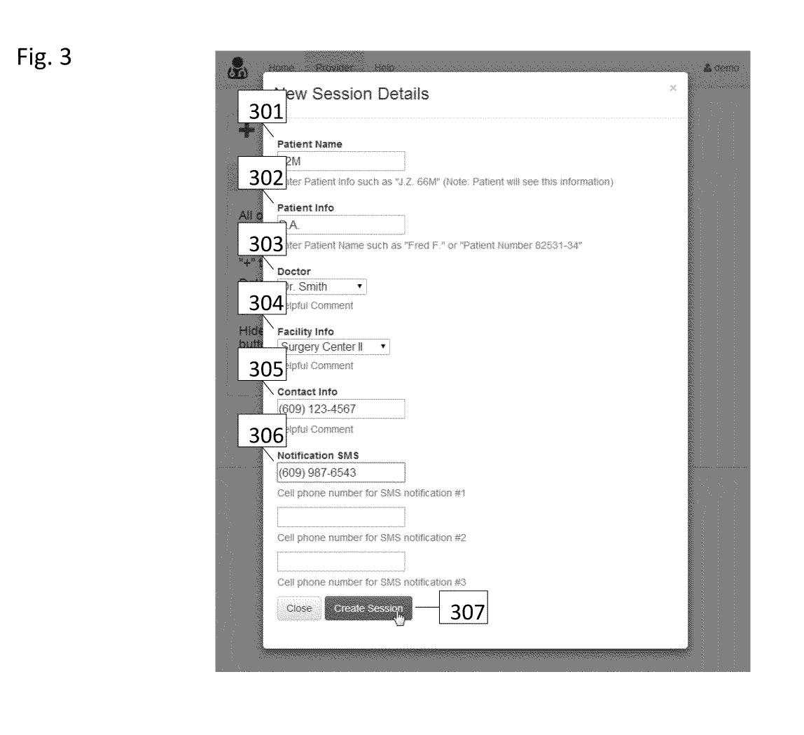

FIG. 4. FIG. 4 illustrates the provider's view where by selecting the procedure button 401, a message template 402 is chosen; from this template the messages 403 can be selected. In another embodiment, the user may enter any text message instead of selecting a prepared message.

FIG. 5. FIG. 5 shows the consumer's view. 501 shows information entered when the session was create by the provider. 502 list all messages of that session along with the time they were transmitted; the topmost highlighted message is the most recent one.

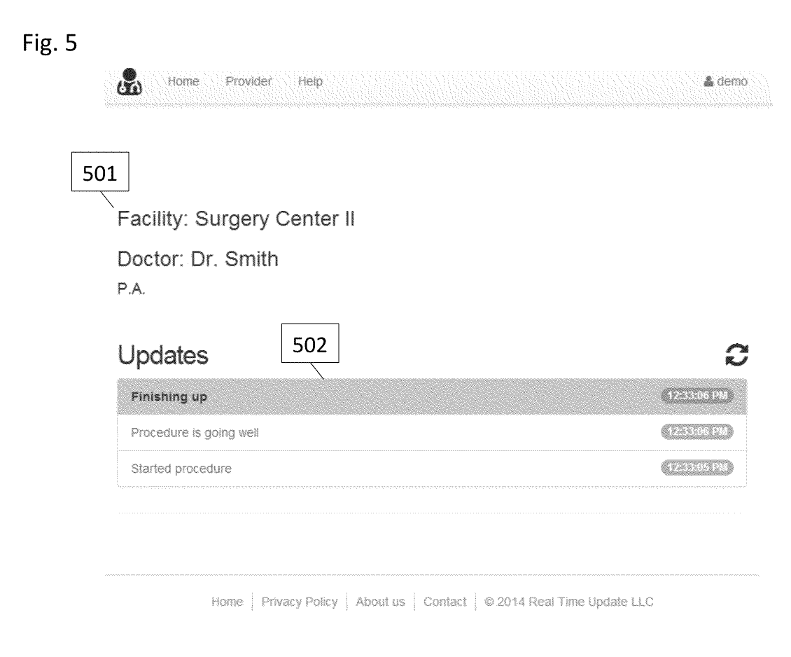

FIG. 6. FIG. 6 presents the architecture of the system: the system provides a portal comprised of an application server 601, a database server 602 and mass storage 603 which can be accessed over a high-speed network 604 and a global communication network 605 by a networked computer 606, or mobile device 607 or a medical device 608.

FIG. 7. FIG. 7 shows one embodiment's data model when the invention is stored in a relational or non-relational database. Many other implementations and data model are possible; this figure shall only serve as one example of how the data may be represented. Table/Collection 701 stores the provider data including the name of the provider, a unique key, the provider's logo, and other information related to the provider. Each provider may be associated with multiple message templates 702, from which the messages are selected for transmission. Each user 703 may be associated to a provider 701. Sessions 704 manage key information about each procedure such as patient name, age, email address, time of the procedure. For a session 704, multiple email and SMS/text recipients 705 may be stored. Whenever a message is sent, it is recorded in 706 along with the time it was sent.

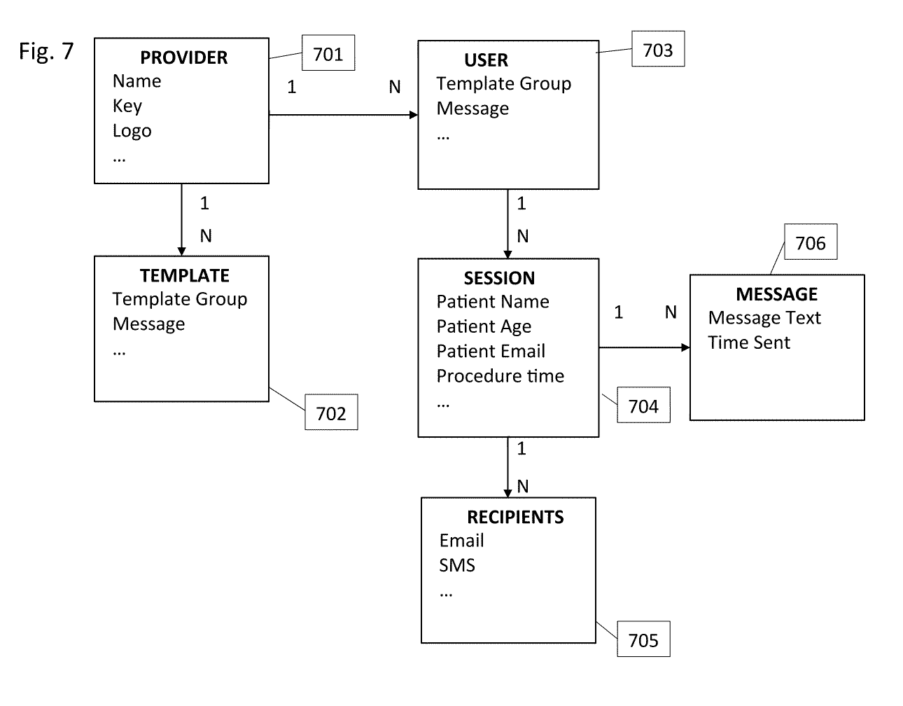

### DETAILED DESCRIPTION AND BEST MODE OF IMPLEMENTATION

The proposed system and method enables privacy-preserving, subscription-based one-way and near-real time communication between two parties, a provider and a recipient.

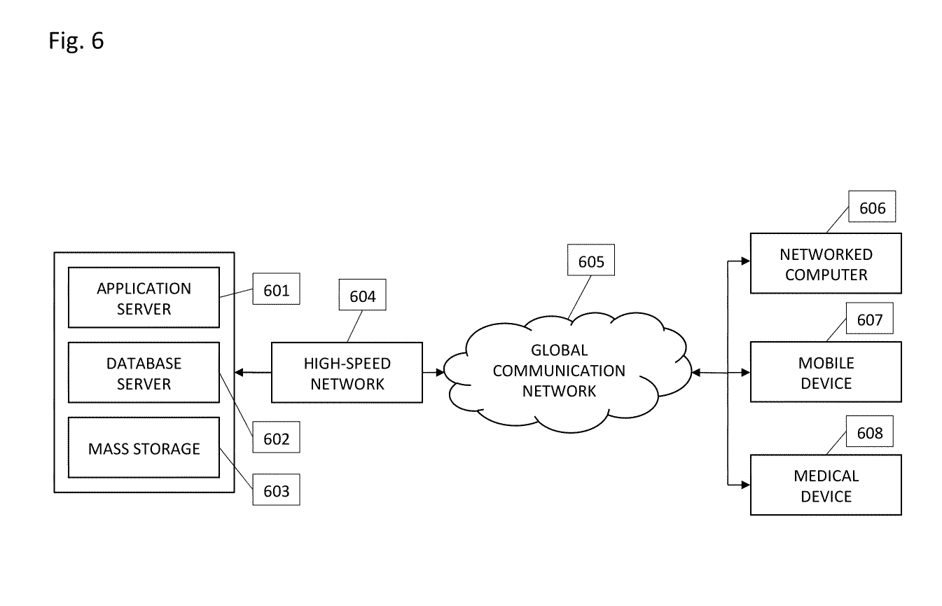

In one embodiment of the invention, the system provides a portal as shown in FIG. 6, comprised of an application server 601, a database server 602 and mass storage 603 which can be accessed over a high-speed network 604 and a global communication network 605 by a networked computer 606, or mobile device 607 or a medical device 608.

The provider may be a medical provider, comprised of a plurality of individuals including doctors, nurses and other staff of the medical facility.

The consumer may a plurality of individuals, for example a patient's family member, friends or other individuals.

Providers and consumers access the system through a plurality of methods including but not limited to an internet web site, designated “apps”, email, cellular SMS, or mobile or medical devices.

The communication between two or more parties is organized in a sessions that exist for a limited duration—such as the duration of a medical procedure between patient admission and patient discharge. The invention organizes and manages communication for a plurality of concurrent providers, consumers and sessions.

Sessions are identified by a unique session identifier such as any combination of random keywords, numbers or symbols. When a provider creates the session, a new session identifier is created and/or chosen by the provider or consumer. This session key is transmitted to the consumer. In one embodiment, the key is entered into a document with instructions on the use of the system. In another embodiment, a QR Code (or other bar code) encoding a WWW Address (URL) is created then enables the consumer to access the session by scanning the QR Code. In yet another embodiment, the key is part of a HTTP(s) hyperlink. As a result, the consumer (recipient of messages) does not need to disclose personal information or set up an account to gain access to the system and will thus remain anonymous.

Sessions are created in an active state when created. Sessions may transition into an inactive state when the predefined session duration is reached or the provider choses to terminate (delete) the session.

Consumers may access the system by specifying the unique session key. Several consumers may access the same session concurrently. A consumer who enters a session key is called a subscriber to that session.

All individuals from the same provider have access to all sessions that are currently active for that provider. They may see all messages posted to the session. All individuals from the provider are subscribers for all active sessions created by that provider.

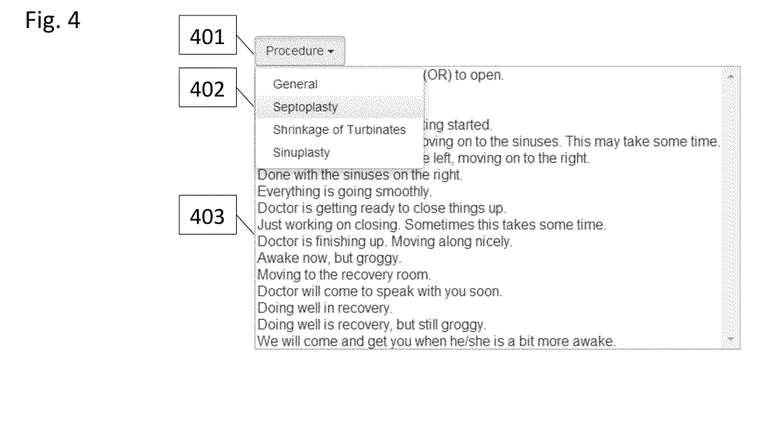

The system provides a configurable set of templates to each provider. (FIG. 4) Each provider may be offered a different set of templates. A template consists of a plurality of textual messages that can be sent by the provider. For each session, the provider may pick messages from any available template for transmission to all recipients that subscribe to the session. A provider may also choose to add, modify or delete such templates, and add messages to, modify or delete messages from templates.

When a new message is selected from a template for transmission, it is transmitted to all the users of the provider and all consumers.

When a new message is available for a consumer, it will appear in real time on the consumer's portal. In one embodiment, the message is transmitted over TCP using “long polling” http requests. In another embodiment, web sockets are used to establish a communication channel between connected components. In yet another embodiment, another standard communication protocol such as TCP or UDP is applied to transmit the message.

Consumers may be alerted to the availability of a new message in a plurality of ways, including, but not limited to aural and/or visual notification on the web site of the system, cellular phone system short message texts (SMS), emails or automatic telephone calls.

Consumers may enable or disable, add or remove notifications to email addresses or cellular phones via SMS at any time.

A provider may also elect to remove a previously sent message in case one was selected by mistake, in which case the pertaining message is removed from all parties systems.

While various embodiments have been described above, it should be understood that they have been presented by way of example only, and not limitation. Thus, the breadth and scope of a preferred embodiment should not be limited by any of the above-described exemplary embodiments. Not all combinations and permutations of elements and methods can be enumerated here, as would be evident to one of ordinary skill in the art. Therefore the presented invention includes any such variation that fall within the present disclosure.

For example, as referred to herein, a server may be a virtual machine, computer, node, instance, host, or machine in a networked computing environment. Furthermore, a server may be a machine deployed to execute a program operating and may include software instances. Also as referred to herein, a networked computing environment is a collection of machines or devices connected by communication channels that facilitate communications between machines and allow for machines to share resources. Resources may encompass any types of resources for running instances including hardware (such as servers, clients, mainframe computers, mobile devices including cell phones, networks, network storage, data sources, memory, central processing unit time, scientific instruments, medical devices and other computing devices), as well as software, software licenses, available network services, and other non-hardware resources, or a combination thereof.

Such networked computing environments include hardware and software infrastructures configured to form a virtual organization comprised of multiple resources, which may be in geographically disperse locations. While TCP/IP communication protocols may be described herein, the coverage of the present application and any patents issuing there from may extend to other communications protocols.

Various terms used herein have special meanings within the present technical field. Whether a particular term should be construed as such a “term of art,” depends on the context in which that term is used. “Connected to,” “in communication with,” “associated with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A computer-implemented method enabling users to transmit on-way progress updates in the form of textual messages in privacy-preserving way, organizing communication in separate sessions for each patient with a unique identifier, enabling users to pick messages from prepopulated templates

2. Method of claim 1, wherein messages are sent to a plurality of recipients by electronic means, including but not limited to email, SMS (text messages) or other protocols, such that the recipient remains anonymous

3. Method of claim 1 wherein message senders may delete previously sent messages
